(19) United States
(12) Patent Application Publication
(10) Pub. No.: US 2009/0194298 A1
(43) Pub. Date: Aug. 6, 2009

(54) METHOD AND APPARATUS IN CONNECTION WITH SPRAYING HEAD AND PROTECTIVE ELEMENT OF SPRAYING HEAD

(76) Inventor: Goran Sundholm, Tuusula (FI)

Correspondence Address: LADAS & PARRY LLP, 26 WEST 61ST STREET, NEW YORK, NY, 10023, US

(21) Appl. No.: 12/303,252

(22) PCT Filed: Jun. 6, 2007
(86) PCT No.: PCT/FI2007/050330

§ 371 Date: Mar. 10, 2009

(30) Foreign Application Priority Data
Jun. 12, 2006 (FI) 20060580

(51) Int. Cl. A62C 35/00

(52) U.S. Cl. 169/51

(57) ABSTRACT

A method in connection with a spraying head, which spraying head comprises at least one nozzle (2) for spraying medium and a protective element (3) which is in a protective position in front of the nozzle (2) and mechanically protects a possible triggering element (14) of the spraying head when the spraying head is in a non-active mode, and which protective element (3) is movable to a second position in which at least one nozzle (2) and the possible triggering element (14) are not protected by the protective element (3). The spraying head is heated at least when required by means of a thermal element (4) arranged into connection with the protective element (3). The invention also relates to an apparatus and a protective element of the spraying head.

### BACKGROUND OF THE INVENTION

The invention relates to a method in connection with a spraying head according to the preamble of claim 1 which spraying head comprises at least one nozzle for spraying medium and a protective element which is in a protective position in front of the nozzle and mechanically protects a possible triggering element of the spraying head when the spraying head is in a non-active mode, and which protective element is movable to a second position in which at least one nozzle and the possible triggering element are not protected by the protective element.

The invention also relates to a protective element of a spraying head according to the preamble of claim 5.

The invention also relates to an apparatus according to claim 8.

Arrangements are known in connection with spraying heads, especially in connection with fire-extinguishing systems, in which a protective element is used as the protection of the spraying head which protective element is in the protective position in front of at least one nozzle of the spraying head and mechanically protects the nozzle and possibly also the triggering element when the spraying head is in the non-active position. The protective element is movable to the second position in which at least one nozzle and the possible triggering element are not protected with the protective element.

A spraying head, especially a sprinkler head, of this type especially intended for fire extinguishing is known e.g. from specification EP1150747. A protective element, such as a cup part, protecting the nozzles and the triggering element of the sprinkler head is released by a device which is movable in relation to the holder frame. The specification presents some different alternatives for releasing the protective element i.e. cup part and for bringing the sprinkler to the stand-by position. From specification U.S. Pat. No. 6,345,670 is known a spraying head which is provided with a protective element.

The spraying heads provided with a protective element in question are used in places where e.g. the surrounding conditions require protecting the spraying head. Typical locations are e.g. traffic tunnels. The conditions prevailing in the location of the spraying head can vary even considerably e.g. in relation to the temperature. Then, conditions can exist which impede the operation of the spraying head, such as a sprinkler head. Such conditions can be e.g. varying weather conditions, such as moisture, temperature etc. Especially freezing conditions can considerably harm the operation of the spraying head.

The object of this invention is to achieve an arrangement by means of which many disadvantages caused by the surrounding conditions of the spraying head to the operation of the releasing mechanism of the spraying head and the protective element are avoided. Another object of the invention is to provide a combination, inter alia, excellent in reliability for a spraying head, especially for a sprinkler, and devices for releasing the protective cup of the sprinkler.

### BRIEF DESCRIPTION OF THE INVENTION

The invention is based on an idea in which the protective element of the spraying head is provided with thermal means.

It is characteristic of the method according to the invention that the spraying head is heated at least when required by means of a thermal element arranged into connection with the protective element.

In addition, the method according to the invention is characterised by what is stated in claims 2-4.

It is characteristic of the protective element of the spraying head according to the invention that the protective element comprises a thermal element.

In addition, the protective element according to the invention is characterised by what is stated in claims 6-7.

It is characteristic of the apparatus according to the invention that into connection with the spraying head is arranged a thermal element.

The apparatus according to the invention is further characterised by what is stated in claims 9-10.

The arrangement according to the invention has numerous significant advantages. By arranging a thermal element into connection with the spraying head, especially into connection with the protective element of the spraying head, an extremely well functioning arrangement for keeping the spraying head in working order also at low temperatures is obtained. The spraying head and the devices in connection with it can thus be heated with the thermal element, if required. According to the invention, the freezing of the spraying head can be prevented by bringing heat with the thermal element. According to an advantageous embodiment, by increasing the heating efficiency of the thermal element, it is possible to affect the triggering element of the spraying head and thus to activate the spraying head, if required. Line elements feeding energy to the thermal element can be used as a coupling part of the protective element to prevent the harmful falling of the protective element. Then, there is no need for a separate fastening arrangement preventing the falling of the protective element. The arrangement is extremely applicable to be located in circumstances in which protecting the sprinkler head is necessary from, inter alia, the surrounding circumstances. Such are e.g. traffic tunnels. The arrangement is extremely applicable namely for fire-extinguishing applications and especially for applications in which liquid-bearing extinguishing medium, such as medium mist, is used as the extinguishing medium.

### BRIEF DESCRIPTION OF THE FIGURES

Next, the invention will be described in detail by means of an example with reference to the accompanying drawing in which

FIG. 1 shows a cross-section of an embodiment of an apparatus according to the invention,

FIG. 2 shows an embodiment of the apparatus according to the invention,

FIG. 3 shows an embodiment of the apparatus according to the invention in a protective position, and

FIG. 4 shows an embodiment of the apparatus according to the invention in a second position i.e. standby position.

### DETAILED DESCRIPTION OF THE INVENTION

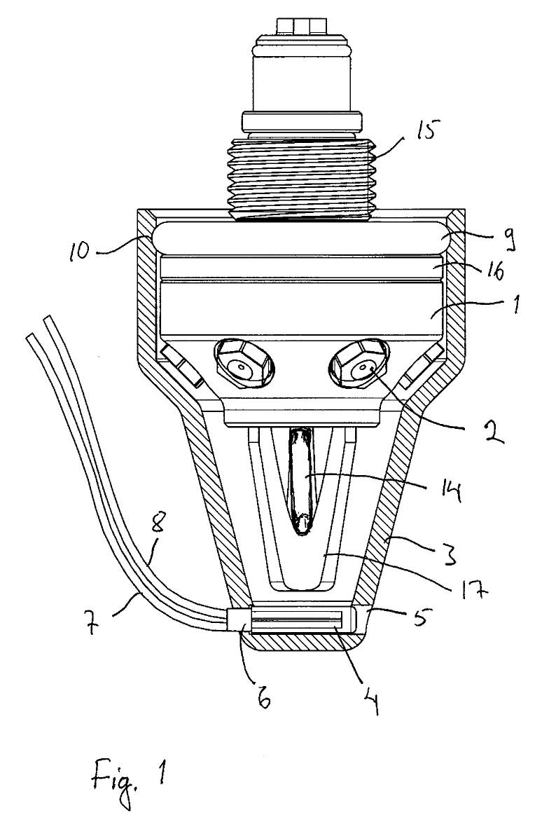

FIG. 1 shows an embodiment of an apparatus according to the invention partly cut. A spraying head is shown separate from the other spraying system. A frame 1 of the spraying head comprises at least one nozzle 2. In the figure, there are several nozzles in the spraying head. Into connection with the spraying head is arranged a protective element 3 which protects at least one nozzle from the effects of the surrounding conditions. Advantageously, the protective element also protects a triggering element 14 possibly arranged in the spraying head, such as in the case according to FIG. 1, when it is a case of a sprinkler head provided with a triggering device intended for fire-extinguishing use. Typically, the triggering element 14 can be e.g. an ampoule or equivalent reacting to heat which breaks after the temperature has exceeded a limit value set for the ampoule and releases a valve element of the spraying head to move into an open position in a way known per se.

The invention relates to an apparatus in connection with a spraying head which spraying head comprises at least one nozzle 2 for spraying medium and a protective element 3 which is in a protective position in front of the nozzle 2 and mechanically protects a possible triggering element 14 of the spraying head when the spraying head is in a non-active mode, and which protective element 3 is movable to a second position in which at least one nozzle 2 and the possible triggering element 14 are not protected by the protective element. It is characteristic of the apparatus according to the invention that into connection with the spraying head is arranged a thermal element 4.

In the embodiment according to the figures, the thermal element 4 is arranged in the protective element 3. To the protective element is formed a bore 5 in which the thermal element 4 is arranged. Energy required by the thermal element is brought by line elements 7, 8 which are coupled to the thermal element in a coupling point 6. The line elements are coupled by a coupling part 11 in a line network 18, 19. The lines 18, 19 of the line network are protected by a protection pipe 20 in the embodiment of the figure. Typically, the energy is electric energy, whereby the thermal element is a resistor element 4. By means of the thermal element, it is possible to maintain adequate heat for the mechanisms of the spraying head to keep them in working order also in unfavourable conditions, such as e.g. in conditions where freezing threatens to prevent the proper operation of the spraying head.

According to another advantageous embodiment, the spraying head is a sprinkler head in which there is a heat-activating triggering means 14 which can be activated by means of thermal energy brought by a thermal element 4. In this embodiment, heating efficiency is increased, whereby it is possible to increase the temperature above the limit value set for the triggering means 14.

The invention also relates to a protective element 3 of the spraying head which element is intended for protecting at least one nozzle 2 of the spraying head and also for mechanically protecting a possible triggering element 14 of the spraying head, if required. The protective element according to the invention comprises a thermal element 4.

In accordance with the embodiments according to the figures, the shape of the protective element 3 is cup-like. It is, however, possible that the shape of the protective element is something other. The shape is mostly dependent on the shape of the spraying head to be protected and its location.

Typically, the thermal element 4 comprises a resistor element. According to an embodiment, the thermal element is quite small, e.g. 2-5 mm of its diameter. Its length can be e.g. 10-120 mm. The thermal element operates according to a typical embodiment by electric energy. Typically, its operating voltage is e.g. 3-240 V.

Thus, the invention also relates to a method in connection with a spraying head which spraying head comprises at least one nozzle 2 for spraying medium and a protective element 3 which is in a protective position in front of the nozzle 2 and mechanically protects a possible triggering element 14 of the spraying head when the spraying head is in a non-active mode, and which protective element 3 is movable to a second position in which at least one nozzle 2 and the possible triggering element 14 are not protected by the protective element 3. In the method, the spraying head is heated at least when required by means of a thermal element 4 arranged into connection with the protective element 3.

According to an embodiment of the method, the spraying head is kept in working order, such as the freezing of the spraying head is prevented, by bringing heat with the thermal element 4.

According to another embodiment of the invention, the triggering element 14 of the spraying head is affected by heating and then the spraying head is activated, if required. Then, the heating efficiency has been increased compared to the embodiment in which the working order of the spraying head is maintained.

According to a further embodiment, the line elements 7, 8 feeding energy to the thermal element 4 are used as the coupling part of the protective element 3 to prevent the harmful falling of the protective element 3.

Next, the operation of the spraying head will be described in which the protective element is brought by means of the spraying head from the first position to the second position. Arrangements in which a different kind of locking/releasing device of the protective element is used are described, inter alia, in specifications WO01/26741 (EP1150747) and WO01/26742.

A fastening frame 16 of the sprinkler is arranged in a fastening part 13 arranged in a pipeline 12. According to FIG. 1, to the spraying head are arranged threads 15 and in the fastening part there are counter threads.

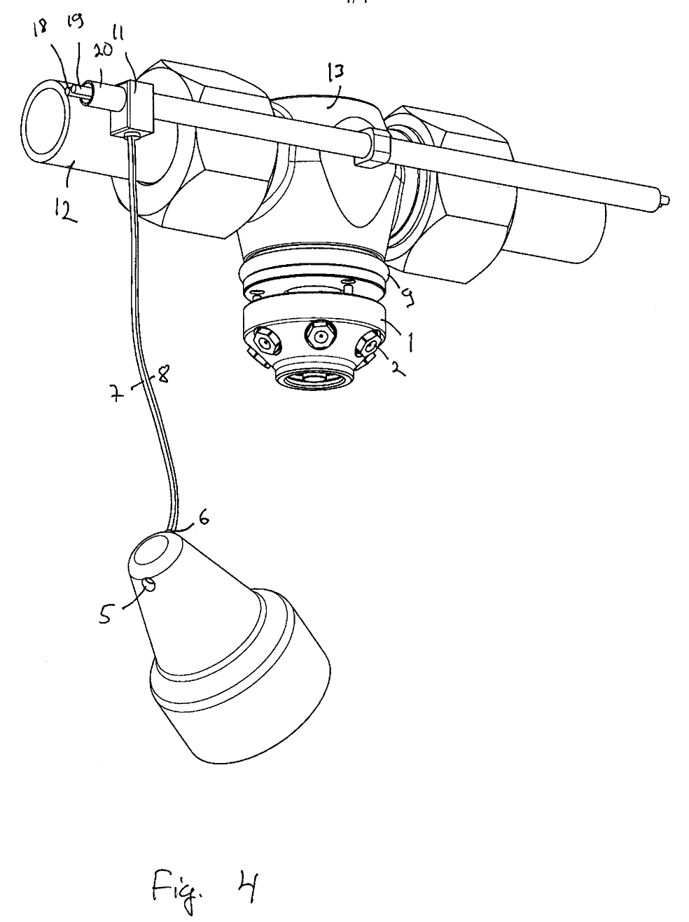

The frame part of the spraying head i.e. the sprinkler frame 1 can be arranged movable in relation to the fastening frame 16 between at least one first position i.e. non-active position (FIG. 1) and one second position i.e. standby position (FIG. 4). At least one nozzle 2 is arranged in the frame part 1 of the sprinkler. There are several nozzles 2 in the sprinkler of the figure. To the sprinkler is arranged the triggering means 14, such as a heat-sensitive triggering means, e.g. an ampoule breaking at a certain temperature. The ampoule 14 is arranged between a support frame 17 in the lower part of the sprinkler frame 1 in FIG. 1 and a valve element of the sprinkler, i.e. valve stem, keeping the passage of the medium closed between an inlet and the nozzles 2 of the sprinkler at least in the non-active position and the standby position.

To the fastening frame 16 of the sprinkler is arranged a channel in which the sprinkler frame 1 is movable between the first position and the second position. When the pressure of the medium in the piping 12 increases, the pressure affects the surfaces of the frame part 1 of the sprinkler which surfaces are formed such that the sprinkler frame moves in the channel 16 of the fastening frame 1 from the first position to the second position, i.e. so far as a counter-surface of the fastening frame.

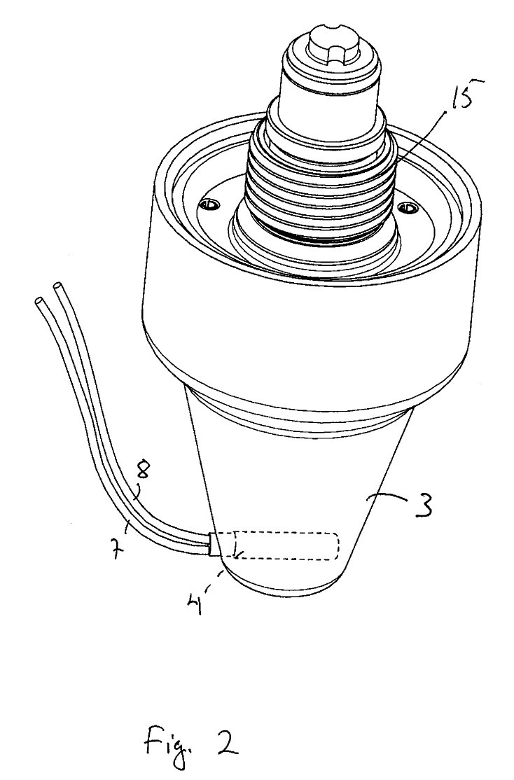

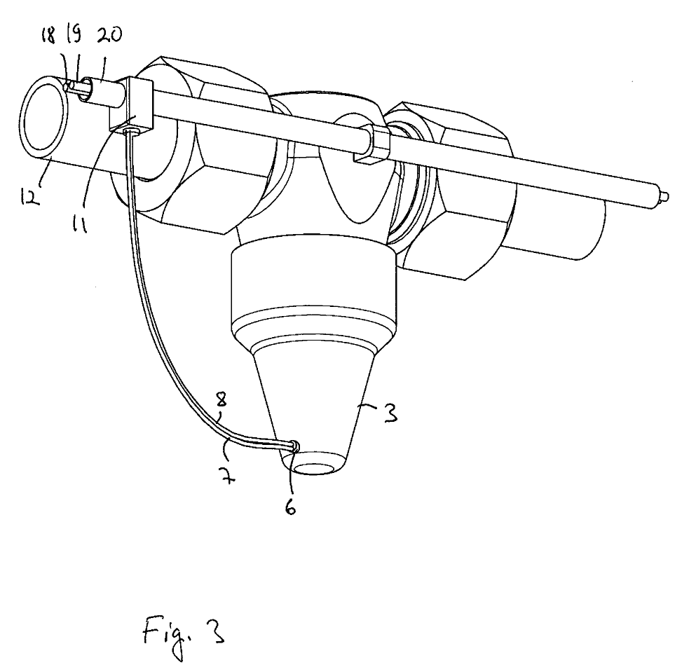

As a result of moving, the sprinkler frame 1 affects the protective element 3. The protective element 3 detaches from the locked position (FIGS. 1, 2 and 3) and moves away from the front of the triggering means and the nozzles (FIG. 4).

The sprinkler comprises the sprinkler frame 1, in which there is at least one nozzle 2, the heat-activated triggering element 14 and the protective element 3, which is in the protective position in front of the nozzle 2 and mechanically protects the triggering element 14 when the sprinkler is in the non-active mode, and which protective element 3 is movable to the second position, in which the nozzles 2 and the triggering element 14 are not protected by the protective element 3. The sprinkler frame 1 is movable in relation to the fastening frame 16 between two positions, the first position in which the sprinkler is in the non-active mode, and the second position in which the sprinkler frame is protruding, and which sprinkler frame 1 is arranged movable from the effect of the pressure of medium in relation to the fastening frame 16 from the first position to the second position and at the same time to direct a force to the protective element 3 for moving it from the protective position to the second position, whereby the sprinkler is in the second position of the sprinkler frame set to the standby mode.

In an embodiment, the medium used for moving the frame part of the sprinkler head i.e. sprinkler frame is typically extinguishing medium. It is also possible to use some other suitable medium.

In the protective position, the protective element 3 extends to the fastening frame 16 or its vicinity. An edge area of the cup-like protective element 3 extends in the embodiment of FIG. 1 over the outer race of the fastening frame 16 so far as the fastening part 9. The fastening part 9 can be e.g. an annular projection, such as a sealing element, for which there is on the inner surface of the protective element a counter element, such as an annular groove 10.

Thus, the spraying head, such as sprinkler head, comprises the cup-like protective element 3 which protects the triggering means 14 and the nozzles 2. The protective element 3 is fastened in the arrangement according to FIG. 1 by means of the sealing element 9, most suitably an annular seal, in the protective position (FIG. 1). To the protective part 3 is formed the groove 10 for the annular seal 9. The groove 10 and the annular seal 9 of the protective part form a locking which keeps the protective part in its place in the protective position. Because of the ring seal 9, the protective element keeps well in its place in the protective position, whereby the vital parts of the sprinkler are well protected from the effects of the sprinkler surroundings. Such parts intended for protection are, inter alia, the triggering means 14, typically an ampoule, and the nozzles 2. The sprinkler can be placed to very different environments where it is exposed to impurities and dirtying which might impede the functioning of the sprinkler, inter alia, to cause malfunctions of the sprinkler without the protective element 3. Furthermore, the protective element 3 prevents the unwanted triggering of the triggering means 14 e.g. as a result of a short hot gas flow directed to the sprinkler. Such situations can occur, inter alia, in road tunnels where e.g. exhaust gases of a lorry can momentarily be directed straight at the sprinkler.

The sprinkler can be set in the standby mode by conveying medium with pressure to the pipe 12. Because of this, the pressure of the medium is directed against the surfaces of the sprinkler, whereby is caused a force which pushes the sprinkler frame 1 in the fastening frame 16 from the first position towards the second position i.e. downwards in FIG. 1. The sprinkler frame 1, for its part, affects the protective part 3, whereby when the force directed by the sprinkler frame 1 to the protective element 3 exceeds the force keeping the protective element in its place, the protective element detaches from its place to the non-protective position according to FIG. 4. The sprinkler frame 1 affects the protective element 3 in the figure in the direction of motion of the sprinkler frame at its outermost part i.e. the support frame 17.

In the arrangement according to the figure, to the protective element 3 is arranged the fastening element for the coupling part by means of which the harmful falling of the protective element 3 is prevented. The coupling part 7, 8 is e.g. a banded part, such as a cord, wire or equivalent or a chain-like part. In the figure, the coupling part is fastened to the protective element 3 and from its other end to the pipe 7, whereby the detached protective element 3 remains hanging held by the coupling part 7, 8.

In the standby mode (FIG. 4), the sprinkler can be activated in a usual way by means of the triggering means 14, e.g. when it has been broken as a result of heat, whereby the nozzles 3 can spray extinguishing medium. In the standby mode and the activated mode, the sprinkler frame 1 according to an embodiment extends somewhat away from the fastening frame 16, whereby it is, on one hand, closer to a possible fire site and, on the other hand, a distance away from the fastening point e.g. a ceiling or wall surface.

Typically, the extinguishing medium pipe 12 is a so-called dry pipe, whereby it does not contain extinguishing medium. When extinguishing medium is conveyed to the pipe 12, the extinguishing medium affects in a manner described above by moving the sprinkler frame from the first position to the second position and to the standby mode whereby also the protective element 3 is detached from its locking. After the ampoule 14 of the sprinkler in the standby mode has been broken e.g. from the result of heat, extinguishing medium starts to spray from the nozzles 2 of the sprinkler.

The arrangement according to the invention is especially suitable for spraying liquid-bearing extinguishing medium mist. On applications and characteristics of the sprinkler, we refer e.g. to specifications EP1150747 and WO01/26742.

It is obvious to those skilled in the art that the invention is not limited to the embodiments described above, but it may be varied within the scope of the enclosed claims. When necessary, the features possibly described in this specification together with other features may also be used separately from each other.

1. A method in connection with a spraying head, which spraying head comprises at least one nozzle (2) for spraying medium and a protective element (3) which is in a protective position in front of the nozzle (2) and mechanically protects a possible triggering element (14) of the spraying head when the spraying head is in a non-active mode, and which protective element (3) is movable to a second position in which at least one nozzle (2) and the possible triggering element (14) are not protected by the protective element (3), characterised in that the spraying head is heated at least when required with a thermal element (4) arranged into connection with the protective element (3).

2. A method according to claim 1, characterised in that the spraying head is kept in working order, such as the freezing of the spraying head is prevented, by bringing heat with the thermal element (4).

3. A method according to claim 1, characterised in that the triggering element (14) of the spraying head is affected with heating and thus the spraying head is activated, if required.

4. A spraying head according to claim 1, characterised in that line elements (7, 8) feeding energy to the thermal element (4) are used as a coupling part of the protective element (3) which prevent the harmful falling of the protective element (3).

5. A protective element (3) of the spraying head which element is intended for protecting at least one nozzle (2) of the spraying head and also for mechanically protecting a possible triggering element (14) of the spraying head, if required, characterised in that the protective element comprises a thermal element (4).

6. A protective element of the spraying head according to claim 5, characterised in that the shape of the protective element (3) is cup-like.

7. A protective element of the spraying head according to claim 5, characterised in that the thermal element (4) comprises a resistor element.

8. An apparatus in connection with a spraying head, which spraying head comprises at least one nozzle (2) for spraying medium and a protective element (3) which is in a protective position in front of the nozzle (2) and mechanically protects a possible triggering element (14) of the spraying head when the spraying head is in a non-active mode, and which protective element (3) is movable to a second position in which at least one nozzle (2) and the possible triggering element (14) are not protected by the protective element (3), characterised in that into connection with the spraying head is arranged a thermal element (4).

9. An apparatus according to claim 8, characterised in that the thermal element (4) is arranged in the protective element (3).

10. An apparatus according to claim 8, characterised in that the spraying head is a sprinkler head in which there is a heat-activating triggering means (14) which can be activated by means of thermal energy brought by the thermal element (4).
